(19) United States
(12) Patent Application Publication
(10) Pub. No.: US 2014/0295562 A1
(43) Pub. Date: Oct. 2, 2014

(54) SAMPLE ANALYZER AND METHOD FOR LOADING REAGENT CONTAINER

(71) Applicant: Sysmex Corporation, Kobe-shi (JP)

(72) Inventors: Yuji WAKAMIYA, Kobe-shi (JP); Tomohiro OKUZAKI, Kobe-shi (JP)

(73) Assignee: Sysmex Corporation, Kobe-shi (JP)

(21) Appl. No.: 14/137,005

(22) Filed: Dec. 20, 2013

(30) Foreign Application Priority Data
Mar. 29, 2013 (JP) 2013-071204

(51) Int. Cl. G01N 35/04

(52) U.S. Cl. CPC G01N 35/04
USPC 436/48; 422/67

(57) ABSTRACT

Disclosed is a sample analyzer, comprising: a container storage configured to store a plurality of reagent containers; a setting chamber including within a setting portion on which at least one reagent container is set; a container detector for detecting the reagent container on the setting portion; a gate to open and close an entrance of the setting chamber; a transferring section configured to hold the reagent container on the setting portion and transfer it to the container storage; and a controller programmed to initiate the transferring section to transfer the reagent container from the setting portion to the container storage if the reagent container is set on the setting portion when the entrance of the setting chamber is closed by the gate.

### RELATED APPLICATIONS

This application claims priority under 35 U.S.C. §119 to Japanese Patent Application No. 2013-071204 filed on Mar. 29, 2013, the entire content of which is hereby incorporated by reference.

### FIELD OF THE INVENTION

The present invention relates to a sample analyzer, and specifically relates to a sample analyzer provided with a container storage for storing reagent containers. The present invention also relates to a method for loading a reagent container to a sample analyzer.

### BACKGROUND OF THE INVENTION

Conventional sample analyzers provided with container holding sections for holding reagent containers are well known (refer to U.S. Pat. No. 8,007,722, for example).

The sample analyzer disclosed in U.S. Pat. No. 8,007,722 has a container holding section for holding a plurality of reagent containers, a setting section for setting a reagent container when introducing and removing a reagent container to/from the container holding section, an elevator device for lifting and lowering the setting section and moving the reagent container on the setting section to the container holding section, and an input device for receiving instructions to transfer or remove a reagent container. In order to set the reagent container in this sample analyzer, the user sets the reagent container on the setting section, then walks to the input device apart from the setting section, and enters a command via the input device to move the reagent container to the sample analyzer. When the command is received, the sample analyzer operates the elevator device to transfer the reagent container on the setting section to the container holding section.

In the sample analyzer disclosed in U.S. Pat. No. 8,007,722, the user has to move between the setting section and the input device in order to set the reagent container.

### SUMMARY OF THE INVENTION

A summary of the present invention is below. It is to be noted that the scope of the present invention is defined solely by the appended claims, and is not affected to any degree by the statements within this summary.

A first aspect of the present invention is a sample analyzer comprising: a container storage configured to store a plurality of reagent containers; a setting chamber including within a setting portion on which at least one reagent container is set; a container detector for detecting the reagent container on the setting portion; a gate to open and close an entrance of the setting chamber; a transferring section configured to hold the reagent container on the setting portion and transfer it to the container storage; and a controller programmed to initiate the transferring section to transfer the reagent container from the setting portion to the container storage if the reagent container is set on the setting portion when the entrance of the setting chamber is closed by the gate.

A second aspect of the present invention is a sample analyzer comprising: a container storage configured to store a plurality of reagent containers; a setting portion configured to accommodate at least one reagent container; a container detector for detecting a reagent container placed on the setting portion; a transferring section configured to hold the reagent container on the setting portion and transfer it to the container storage; a cover forming an exterior of the sample analyzer; and a button for issuing an instruction to start the transfer by the transferring section provided within the cover near the setting portion, wherein the setting portion is configured so as to be exposed when the cover is open, and the transferring section is configured to start transferring a reagent container placed on the setting portion when the button is operated and a reagent container is detected on the setting portion.

A third aspect of the present invention is a method for loading reagent container in a container storage of a sample analyzer, comprising the steps of: setting at least one reagent container on a setting portion within a setting chamber through an entrance of the setting chamber; closing the entrance with a gate equipped with the sample analyzer; and starting loading of the reagent container on the setting portion into the container storage by a transferring section of the analyzer when triggered by the closing of the gate on the entrance.

### BRIEF DESCRIPTION OF THE DRAWINGS

FIG. 1 is a brief perspective view showing the overall structure of the sample analyzer of a first embodiment;

FIG. 2 is a brief plan view showing the disposition of each part in the sample analyzer of the first embodiment;

FIG. 3 is a block diagram illustrating the control structure of the sample analyzer of the first embodiment;

FIG. 4 is a brief plan view illustrating the structure of the container storage of the sample analyzer of the first embodiment;

FIG. 5 is a brief vertical section view of the container storage shown in FIG. 4;

FIG. 6 is a brief perspective view showing the structure of the transferring section of the sample analyzer of the first embodiment;

FIG. 7 is a brief perspective view of the sample analyzer of FIG. 1 when the cover is open and the container transferring station is exposed;

FIG. 8 is a flow chart illustrating the transfer operation for replacing a reagent container with a new container in the sample analyzer of the first embodiment;

FIG. 9 is a flow chart illustrating the transfer operation for discharging a reagent container in the sample analyzer of the first embodiment; and

FIG. 10 is a brief perspective view of the sample analyzer of a second embodiment when the cover is open and the container transferring station is exposed.

### DETAILED DESCRIPTION OF THE PREFERRED EMBODIMENTS

The embodiments of the present invention are described below based on the drawings.

### First Embodiment

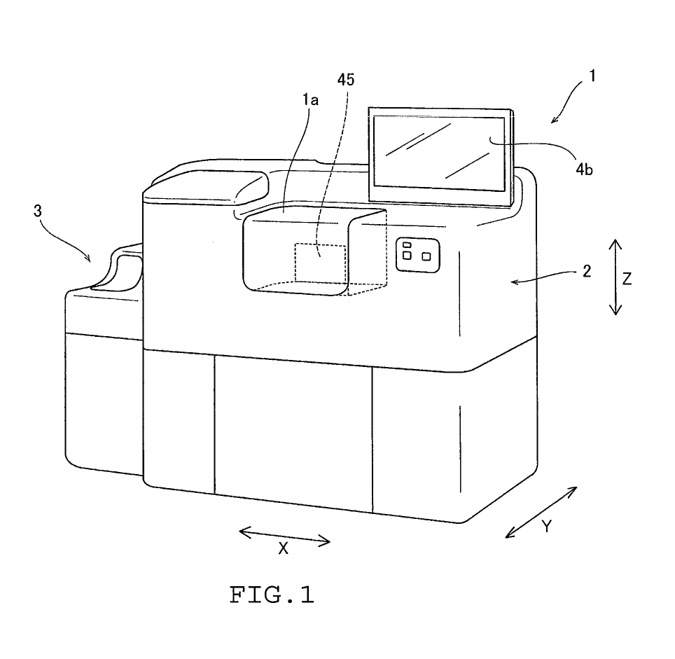

The structure of the sample analyzer of the first embodiment is described below with reference to FIGS. 1 through 7.

The sample analyzer 1 of the first embodiment is an immunological analyzer which quantitatively measures antigens and antibodies contained in samples. Samples are blood samples, and preferably serum samples.

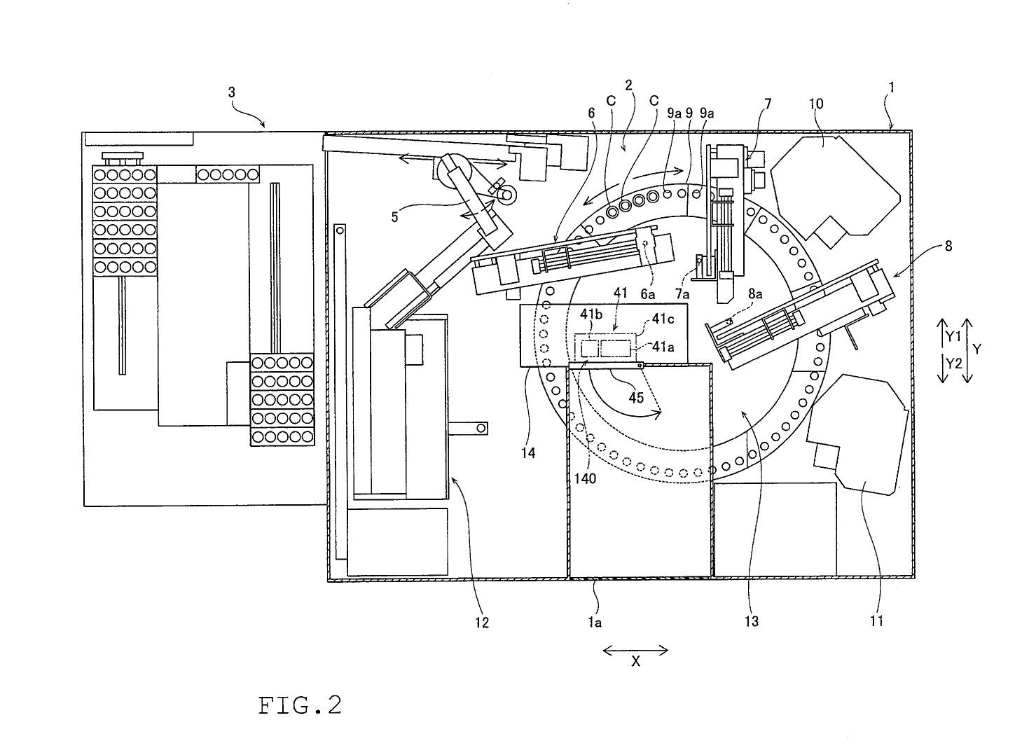

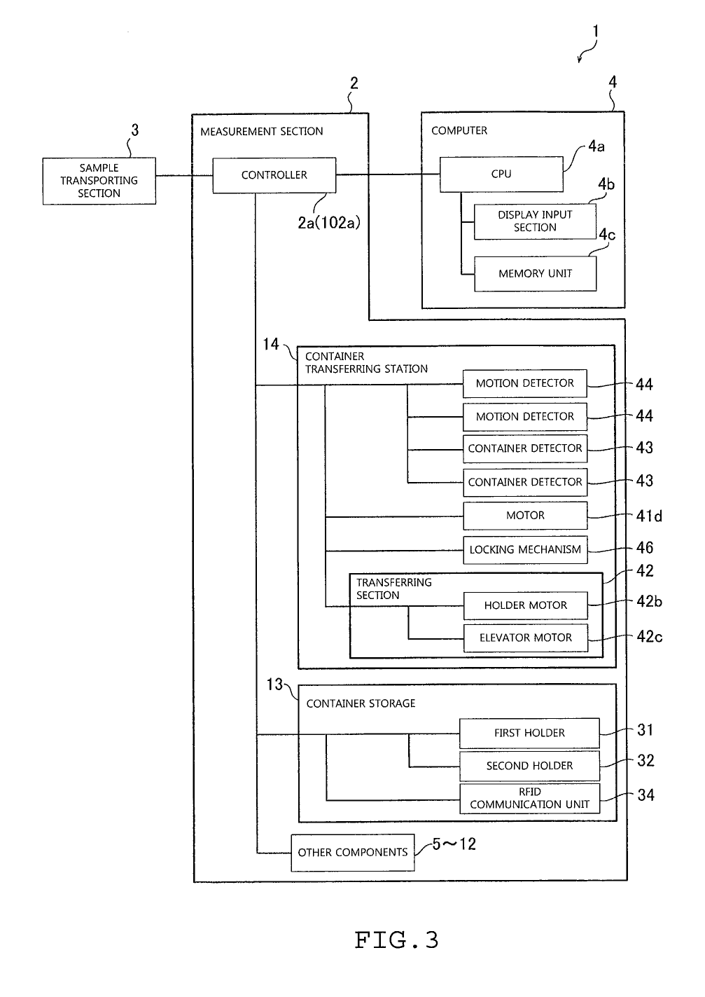

As shown in FIGS. 1 and 2, the sample analyzer 1 has a measurement section 2 for preparing and measuring an measurement sample prepared from a sample and reagent, a sample transporting section 3 dispose adjacent to the measurement section 2, and a computer 4 (refer to FIG. 3) electrically connected to the measurement section 2.

As shown in FIG. 2, the sample transporting section is configured to move a rack holding a plurality of test tubes containing samples. The sample transporting section moves the test tube containing the sample to a sample aspirating position at which a sample dispensing arm 5 accesses to the test tube.

As shown in FIG. 3, the computer 4 includes a CPU 4a, touch panel type display input section 4b, and memory unit 4c. The CPU 4a performs the functions of analyzing the measurement data of the measurement sample prepared using sample and reagent, and displaying the analysis results on the display input section 4b. The memory unit 4c includes a hard disk drive HDD, and stores the various programs and measurement result data. The main body incorporating the CPU 4a and memory unit 4c of the computer 4 is housed within the body of the sample analyzer 1, and the display input section 4b is disposed in the upper section of the apparatus (refer to FIG. 1). The computer 4 displays a reagent management screen which shows a list of reagent information of the reagents set in the container storage 13 on the display input section 4b. The computer 4 receives instructions to remove the reagent containers from the user on the reagent management screen.

As shown in FIG. 2, the measurement section 2 is mainly configured by a sample dispensing arm 5, reagent dispensing arms 6 through 8, reactor 9, B/F separation stations 10 and 11, measurement station 12, container storage 13, and container transferring station 14. As shown in FIG. 3, each components in the measurement section 2 is controlled by a controller 2a provided within the measurement section 2. The controller 2a is connected to the sample transporting section 3 and the computer 4 so as to enable communication therebetween, and receives operation instructions from the computer 4, transmits measurement result data to the computer 4, and transmits operation instructions to the sample transporting section 3.

The sample dispensing arm 5 is configured to be movable, and aspirates the sample in the test tube transported by the sample transporting section 3, and dispenses the aspirated sample into a cuvette C. The cuvette C is a reaction container for preparing a measurement sample from dispensed sample and reagent.

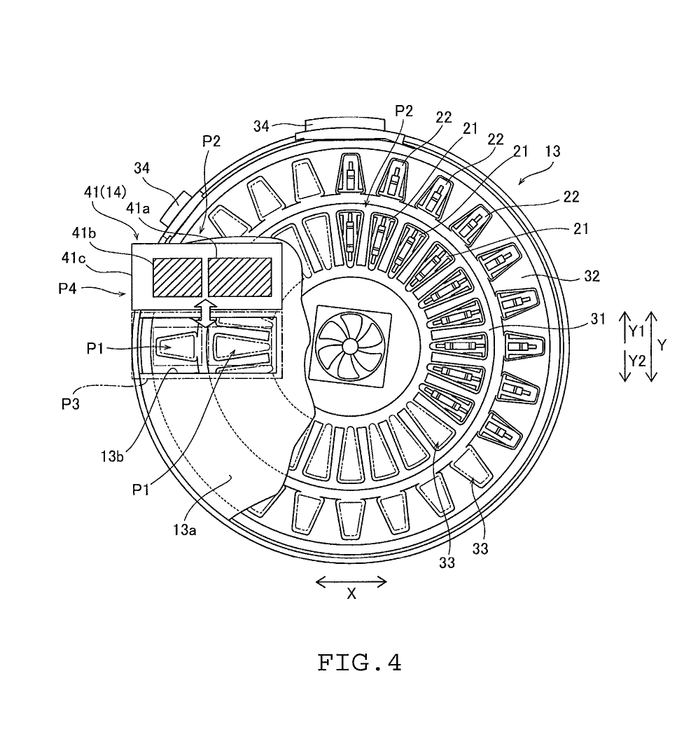

As shown in FIG. 2, the reagent dispensing arms 6 through 8 have pipettes 6a through 8a, respectively. The reagent dispensing arms 6 through 8 aspirate each type of reagent from reagent containers 21 and 22 (refer to FIG. 4) installed in the container storage 13 via the respective pipette, and dispense the aspirated reagent into the cuvette C.

The reactor 9 is substantially annular in shape in planar view, so as to circumscribe the perimeter of the container storage 13 which is substantially circular in shape. The reactor 9 is configured to be rotatable in clockwise and counterclockwise directions, and moves the cuvette C held in the cuvette holder 9a to various processing stations.

The B/F separation stations 10 and 11 perform the separation process to remove unnecessary components from the mixture of sample and reagent in the cuvette C.

The measurement unit 12 measures the immunological reaction in the sample by obtaining the light produced by the reaction process of the measurement sample prepared by mixing the sample and reagent. In the sample analyzer 1, dispensing of samples and various reagents, and separation processing are performed on the cuvette C traveling to the measurement station 12 by clockwise rotation of the reactor 9, and ultimately measurements are performed by the measurement station 12.

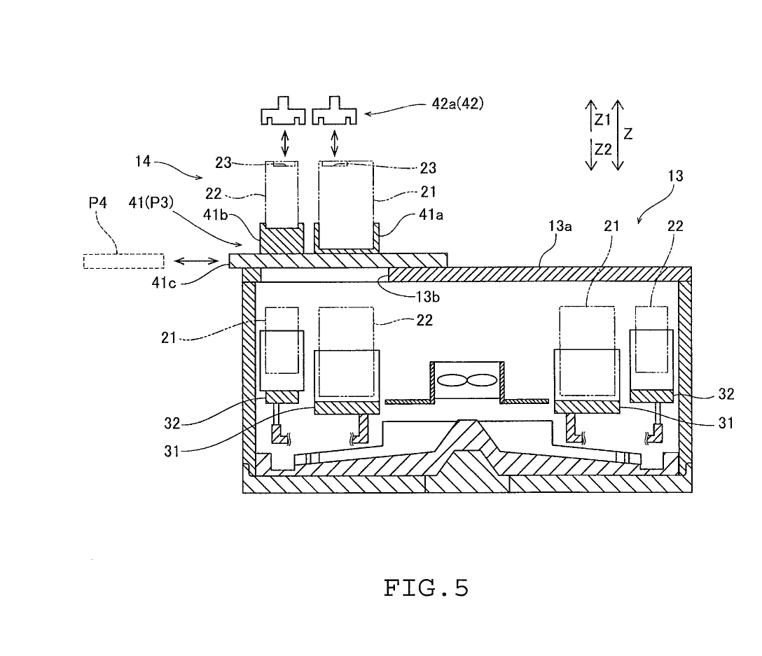

As shown in FIGS. 4 and 5, the container storage 13 is a circular housing part disposed within the reactor 9. A plurality of reagent containers 21 and reagent containers 22 can be respectively installed in the container storage 13. The container storage 13 is a reagent cooler, and functions to cool the reagent within the reagent containers 21 and 22 set therein to a predetermined temperature. The container storage 13 is surrounded by an insulating wall.

The container storage 13 is provided with an annular first holder 31 for aligning large reagent containers 21 in an annular array, and an annular second holder 32 for aligning small reagent containers 22 in an annular array on the outer side of the first holder 31 in the diameter direction. A plurality of concave slots 33 are provided in the first holder 31 for setting the reagent containers 21. A plurality of concave slots 33 are similarly provided in the second holder 32 for setting the reagent containers 22. The first holder 31 and the second holder 32 are arranged in concentric circles, and are independently rotatable on the common axis. Although the reagent containers may have the same shape, the reagent accommodated therein need not necessarily be the same, hence these containers may hold different reagents. Reagent information such as the type, amount (number of possible measurements), lot number, expiration date and the like of the accommodated reagent is recorded on an RFID tag attached to the individual reagent container.

The top surface 13a of the container storage 13 has an opening 13b for introducing and removing the reagent containers 21 and 22 to/from the container storage 13, and an opening (not shown in the drawing) allowing reagent aspiration from the reagent containers 21 and 22 via the reagent dispensing arms 6 through 8. The reagent containers 21 and 22 which contain the reagent to be dispensed are respectively positioned at the reagent aspirating position by rotating the first holder 31 and second holder 32. The pipettes 6a through 8a access the interior of the reagent container disposed at the reagent aspirating position, and aspirate the reagent container therein. When removing empty reagent container 21 or 22, the slot 33 accommodating the reagent container 21 or 22 to be removed is disposed at the reagent transfer position P1 directly below the opening 13b. When replacing reagent containers 21 and 22 with new ones, the slot into which the new reagent container will be set is disposed at the reagent transfer position P1 directly below the opening 13b. Therefore, setting and removal of reagent container 21 or 22 are performed through the common opening 13b.

The container storage 13 is provided with an RFID (radio frequency identification) communication unit 34, and the reagent information is acquired by communication between the RFID communication unit 34 and the RFID tag (not shown) provided on individual reagent containers 21 and 22. The RFID communication unit 34 communicates with the RFID tag of the reagent containers 21 and 22 disposed at the reading position P2 at the front of the RFID communication unit 34. Whether a reagent container is set in the slot 33 is recognized by positioning each slot 33 of the first holder 31 and second holder 32 at the reading position P2. When setting a new reagent container 21 and 22, the empty slot 33 which has been recognized by the RFID communication unit 34 is selected.

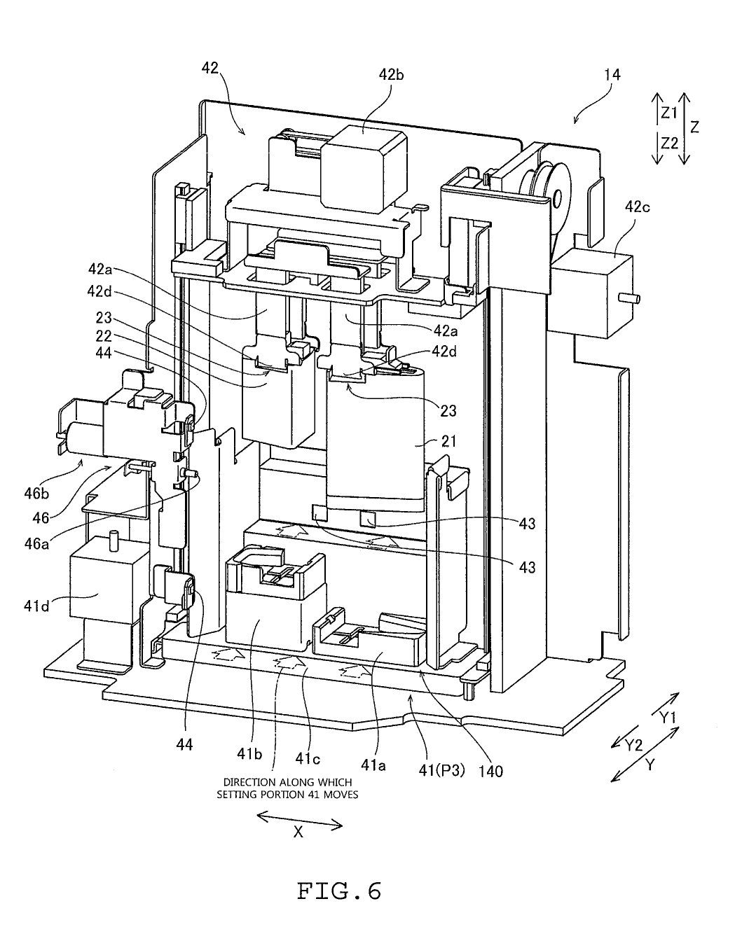

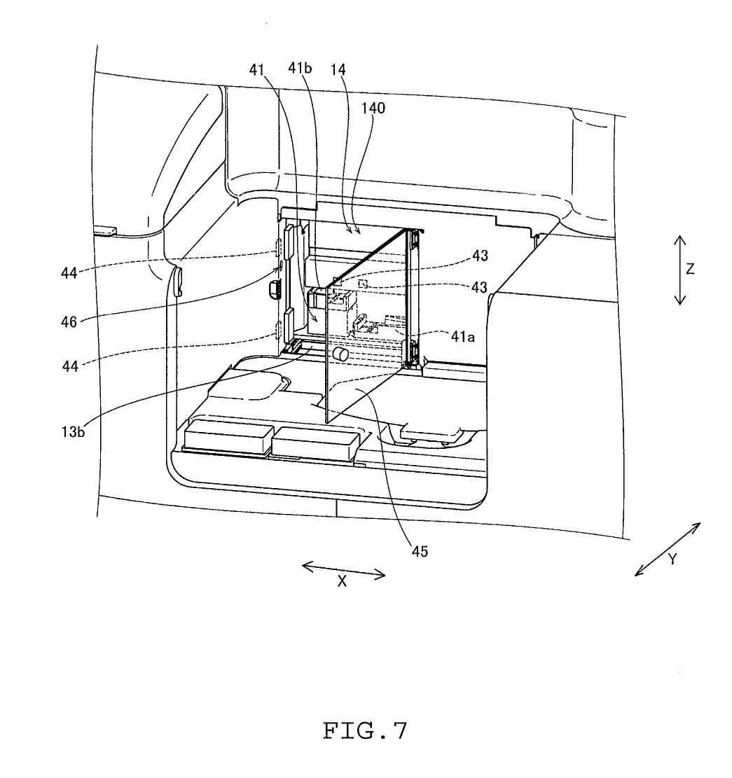

When the cover 1a (refer to FIG. 1) is opened on the sample apparatus 1, the entrance is exposed to the setting chamber 140 which is closed by the gate. The entrance of the setting chamber 140 is closed by a door 45 (refer to FIG. 7) which functions as a gate that can be opened and closed. The container transferring station 14 is disposed at the inside of the door 45, above the container storage 13. As shown in FIG. 6, the container transfer station 14 is configured by a setting portion 41, transferring section 42, container detector 43, motion detector 44, and locking mechanism 46. The setting portion 41, transferring section 42, and container detector 43 are arranged within the setting chamber 140. As shown in FIGS. 1 and 7, the interior of the setting chamber 140 can be accessed by the user through the entrance by opening the door 45.

As shown in FIG. 6, the reagent containers 21 and 22 are set on the setting portion 41 when replacing the reagent containers in the container storage 13. The setting portion 41 is configured to accommodate both the reagent container 21 and the reagent container 22, and includes a setting base 41 a for setting a large reagent container 21 and a setting base 41b for setting a small reagent container 22.

The setting portion 41 is arranged above the container storage 13 so as to overlap the container storage 13 in a plan view, and is configured to move in horizontal directions to open and close the opening 13b of the container storage 13 as shown in FIG. 4. The setting portion 41 has a plate-like shutter 41c on which are provided two setting bases 41a and 41b, and the shutter 41c is movable in the Y1 direction and the Y2 direction by actuating a drive device (not shown) via a motor 41d, as shown in FIG. 6. Hence, the setting portion 41 opens and closes the opening 13b by moving between a first position P3 which overlaps the position of the opening 13b of the container storage 13, and a second position P4 which opens the opening 13b, as shown in FIG. 4. When the setting portion 41 is moved to the second position P4, the opening of the container storage 13 is open. Note that FIG. 5 illustrates the second position P4 shifted laterally for ease of illustrating the movement of the setting portion 41.

As shown in FIGS. 5 and 6, the transferring section 42 works to hold the reagent containers 21 and 22 set on the setting portion 41, and move the containers through the opening 13b of the container storage 13 into the interior of the container storage 13. The transferring section 42 holds and moves the reagent container 21 and the reagent container 22 simultaneously. The transferring section 42 is configured by two holders 42a for respectively holding the reagent containers 21 and 22, a holder motor 42b for performing the holding operation of the holders 42a, and an elevator motor 42c for lifting and lowering the holders 42a, as shown in FIG. 6.

The two holders 42a are two arm devices arranged at a position directly above the respective setting bases 41 a and 41 b when the setting portion 41 is at the first position P3 (shown in FIG. 6). The holders 42a have engaging hooks 42d at the tip of the pair of arm devices, and hold the reagent containers when the engaging hooks 42d engage from both sides at the concavity 23 provided at the top end on bilateral sides of the reagent containers. The holder motor 42b increases the space between the pair of engaging hooks 42d to release the reagent container and reduces the space between the pair of engaging hooks 42d to catch the reagent container by driving the drive device (not shown).

The two holders 42a are configured to be linearly movable in vertical directions by driving a drive device (not shown) via the elevator motor 42c. The transferring section 42 thus holds and moves the reagent containers 21 and 22 upward (Z1 direction) from the setting portion 41 at the first position P3. The reagent containers are lifted from the setting base in this way. After the setting portion 41 is moved to the second position P4 (refer to FIG. 4), the transferring section 42 then moves the reagent containers 21 and 22 to the container storage 13 through the opening 13b (refer to FIG. 5) by lowering.

The large reagent container 21 and the small reagent container 22 contain reagents for a predetermined number of measurement. The different sizes of the containers are due to the different quantities used in a single measurement. Therefore, when usage of the reagent container 21 and the reagent container 22 starts simultaneously, they will become empty at the same time after a predetermined number of dispensations. The container transfer station 14 is configured to move both the reagent container 21 and the reagent container 22 into the container storage 13 at the same time.

The container detectors 43 detect the reagent containers 21 and 22 set on the setting portion 41 respectively. The controller 2a can recognize the presence or absence of each of the reagent containers 21 and 22 on the setting portion 41 according to the result of detection. The container detectors 43 are optical sensors disposed on the inside wall (Y1 direction side) so as to face the reagent containers on the setting bases 41a and 41b. Two container detectors 43 are provided to correspond to the two setting bases 41a and 41b. When the reagent containers 21 and 22 are set on the setting bases 41a and 41b, a detection light reflected by the container is received by the optical sensors to detect each container.

The motion detector 44 is disposed near the setting portion 41, and is configured to detect the opening and closing the door 45. The motion detector 44 has a pair of magnetic sensors vertically arranged on frame of the entrance to detect the internal magnet (not shown) built inside the door 45 at the closed position. The motion detector 44 detects the open state and closed state of the door 45.

As shown in FIG. 7, the door 45 is a gate configured to open and close the entrance part of the setting portion 41. The door 45 is a hinged type door. The door 45 is switchable between an open state which allows the reagent containers 21 and 22 to be added and removed to/from the setting portion 41, and a closed state which prevents the access to the setting portion 41. The user opens the door 45 to expose the setting portion 41, places the reagent containers 21 and 22 thereon, then closes the door 45.

As shown in FIGS. 6 and 7, the locking mechanism 46 is part of the entrance near the setting portion 41 which is provided at the closed position of the door 45 in order to lock the door 45 in the closed state. The locking mechanism 46 includes a locking pin 46a arranged between the pair of motion detectors 44, and a reciprocating device 46b for advancing and retracting the locking pin 46a from inside of the entrance wall to the door 45 side. Hence, the locking mechanism 46 locks the door 45 in the closed state by extending the locking pin 46a to engage a concavity (not shown) on the end surface of the door 45, and pulling back the locking pin 46a to unlock the door 45.

The container transfer operation to the container storage 13 performed by the container transferring station 14 is controlled by the controller 2a provided in the measurement section 2. In the first embodiment, the controller 2a is configured to control the container transfer operation based on the output of the two container detectors 43 and the two motion detectors 44. That is, when the controller 2a detects the reagent containers 21 and 22 on the setting portion 41 and the door 45 is closed, the controller 2a controls the transferring section 42 to move the reagent containers 21 and 22 to the container storage 13.

The controller 2a prohibits the start of the container transfer when the door 45 is closed but neither reagent container 21 or reagent container 22 is detected on the setting portion 41. On the other hand, the controller 2a starts the container transfer when either the reagent container 21 or reagent container 22 is detected by the container detector 43. The controller 2a locks the door 45 via the locking mechanism 46 before starting the transfer of the reagent container 21 and 22. Note that although FIG. 7 shows the door 45 opened with the setting portion 41 moved to expose the opening 13b of the container storage 13, it is mere an illustration for helping understanding of structure, and such situation does not occur in the actual control.

The reagent container transfer process of the sample analyzer 1 of the first embodiment is described below with reference to FIGS. 4, 5, and 7 through 9. The transfer process is an operation controlled by the controller 2a of the measurement section 2. The setting of each reagent container in the container storage 13 as a result of the transfer process is reflected on the computer 4 side via a result communication from the controller 2a.

The reagent container transfer process includes a process to replenish the reagent containers 21 and 22 with new reagent containers 21 and 22 in the empty slots in the container storage 13, and a discharge process to remove or replace the empty reagent containers. The new replenishment process is described below.

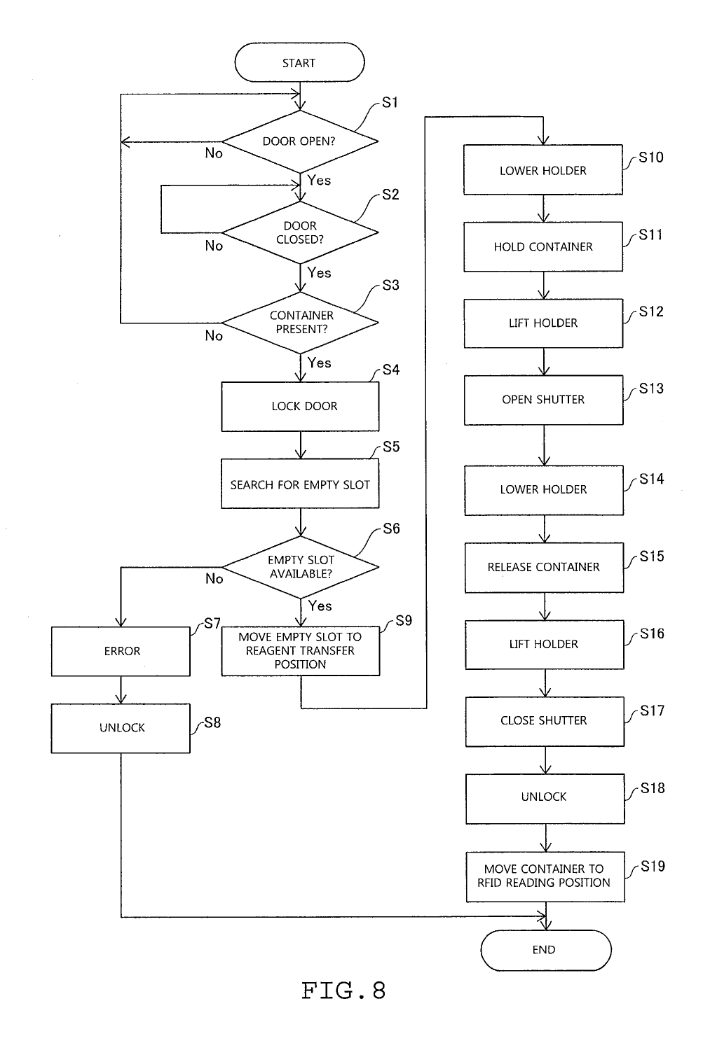

In step S1 of FIG. 8 the controller 2a determines whether the door 45 is open (refer to FIG. 7) based on the output of the two motion detectors 44. The process of step S1 is repeated in a standby state until the operation of opening the door 45 is detected. When the door 45 is opened by the user, the transfer process of step S2 and subsequent steps is started.

When the opening of the door 45 is detected, the controller 2a determines whether the door 45 is closed based on the output of the motion detector 44 in step S2. The determination process of step S2 is repeated until the door 45 is closed. Thus, the completion of setting the new reagent containers 21 and 22 on the setting portion 41 by the user is awaited. After container setting is completed and the closed door 45 is detected, the process continues to step S3.

In step S3, the controller 2a determines the presence/absence of the reagent containers 21 and 22 set on the setting portion 41 based on the output of the two container detectors 43. When no reagent container is detected, the process returns to step S1. When at least one of the reagent containers 21 and 22 is detected, the process advances to step S4 and the controller 2a starts the transfer operation.

In step S4, the locking mechanism 46 is operated to lock the door 45 in the closed state. The user therefore cannot access the interior of the chamber 140 until the transfer process is completed, that is, until the subsequent step S8 or S18 ends.

In step S5, the controller 2a performs processing to sequentially move the each slot 33 of the first holder 31 and second holder 32 of the container storage 13 to the reading position P2 (refer to FIG. 4), and perform the reading process by the RFID communication unit 34. The controller 2a therefore searches for empty slots in the first holder 31 and second holder 32. In step S6, the controller 2a determines the presence/absence of empty slots.

When the search results of all slots confirm no empty slots, the controller 2a outputs an error notice to the computer 4 in step S7. The computer 4 then displays an error message on the display/input section 4b. The error display may include a message such as “Empty slot not found. Please see the reagent management screen and designate reagent to be replaced.” In step S8, the controller 2a causes the locking mechanism 46 to unlock the door 45. In this case the user issues an instruction to replace the reagent containers based on the error display, and removes the empty reagent containers 21 and 22 accordingly.

When an empty slot is identified in step S6, the process advances to step S9. In step S9, the controller 2a rotates the first holder 31 and second holder 32 to dispose the empty slot at the reagent transfer position P1 directly below the opening 13b. Note that the controller 2a determines that the initially identified empty slot as the slot 33 which is to receive the new reagent container for each of the first holder 31 and second holder 32. Accordingly, in practice the process advances to step S9 when an empty slot 33 is identified and steps S5 and S6 are not limited to being performed for all slots 33.

The transfer operation of the reagent containers 21 and 22 by the container transferring station 14 continues in parallel with the movement of the empty slot in the container storage 13 in step S9. That is, the controller 2a lowers the holders 42a via the elevator motor 42c to reach the upper portion of the reagent container 21 and 22 in step S10, and the reagent containers 21 and 22 are chucked in the holders 42a via the holder motor 42b in step S11. In step S12, the controller 2a raises the holder 42a and thereby lifts the reagent containers 21 and 22. In step S13, the shutter part 41 c is moved in the Y1 direction from the first position P3 to the second position P4 (refer to FIG. 4). The interior of the container storage 13 is therefore exposed through the opening 13b. At this time the empty slot has been disposed at the reagent transfer position (refer to step S9).

In step S14, the controller 2a lowers the holder 42a through the opening 13b and sets the reagent containers 21 and 22 in the empty slots of the container storage 13. In step S15, the controller 2a releases the grip of the holder 42a on the reagent containers 21 and 22. As a result, the reagent containers 21 and 22 are set in the empty slots of the first holder 31 and second holder 32.

Thereafter, in step S16, the controller 2a raises the holder 42a to a predetermined height above the opening 13b. The controller 2a then moves the shutter 41 c in the Y2 direction from the second position P4 to the first position P3 to close the opening 13b in step S17. In step S18, the controller 2a cancels the lock of the door 45 by the locking mechanism 46. In step S19, the controller 2a moves the reagent containers recently set in the first holder 31 and second holder 32 to the reading position P2. The controller 2a controls the RFID communication unit 34 to perform the reading process to read the reagent information on the RFID tags of the reagent containers 21 and 22. The read information is transmitted together with the slot position information from the controller 2a to the computer 4.

The computer 4 receives the information from the controller 2a, displays the reagent management screen on the display input section 4b to show the information of the reagent containers 21 and 22 set in the slots 33 of the first holder 31 and second holder 32, and the reagent information of the recently set reagent containers 21 and 22 is reflected on the screen. The process of replenishment of the reagent containers 21 and 22 is therefore complete.

The discharge process for removing or replacing the reagent containers 21 and 22 held in the container storage 13 is described below.

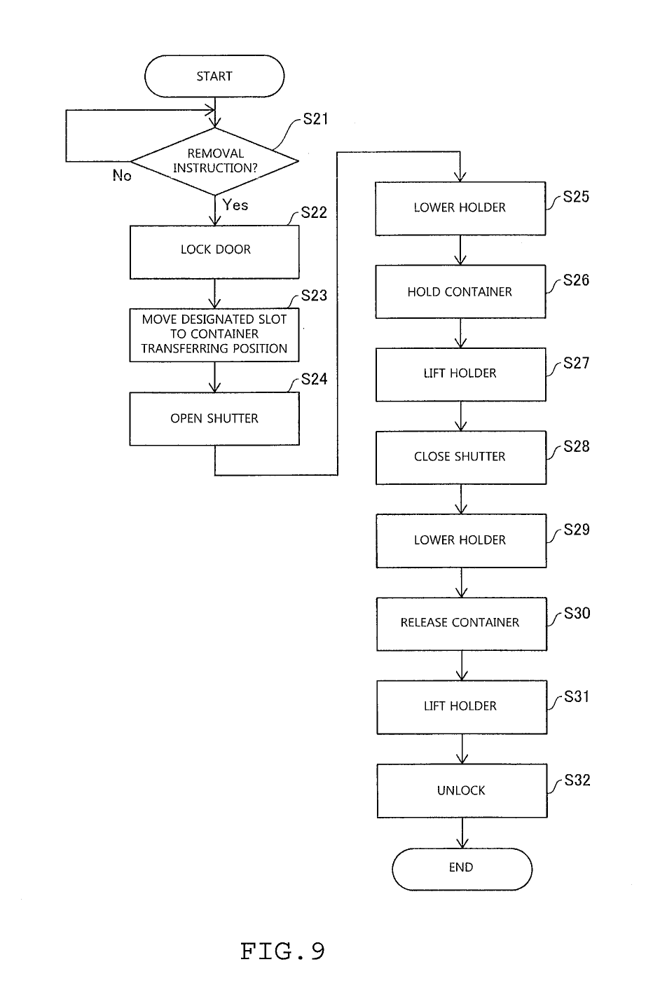

In step S21 of FIG. 9, the controller 2a determines whether a removal instruction has been received for the reagent containers 21 and 22. The removal instruction is output from the computer 4 to the controller 2a when the user inputs the removal instruction by designating the reagent containers 21 and 22 from the reagent management screen on the display input section 4b. Until this removal instruction is received, the process of step S21 is repeated and a standby state is maintained. When the user inputs the removal instruction, the discharge process of step S22 and subsequent steps is started.

When the removal instruction is received, the controller 2a controls the locking mechanism 46 to lock the door 45 in step S22. In step S23, the controller 2a disposes the slot 33 holding the designated reagent containers 21 and 22 in the container storage 13 at the reagent transfer position P1 directly below the opening 13b. In step S24, the controller 2a moves the shutter 41c from the first position P3 to the second position P4 (refer to FIG. 4) to open the opening 13b.

In step S25, the controller 2a lowers the holders 42a through the opening 13b to the container storage 13. In step S26, the controller 2a causes the holder 42a to chuck the reagent containers 21 and 22. In step S27, the controller 2a raises the holder 42a and lifts the chucked reagent containers 21 and 22 through the opening 13b to a predetermined height.

In step S28, the controller 2a moves the shutter 41c from the second position P4 to the first position P3 to close the opening 13b of the container storage 13. In step S29, the controller 2a controls the elevator motor 42c to lower the holder 42a and dispose the held reagent containers 21 and 22 on the setting bases 41a and 41b. In step S30, the controller 2a causes the holder 42a to releases the reagent container.

In step S31, the controller 2a raises and retracts the holder 42a to/from a predetermined height position. In step S32, the controller 2a unlocks the door 45 by the locking mechanism 46. The user can thus open the door 45 and remove the reagent containers 21 and 22 from the setting portion 41.

The reagent containers 21 and 22 discharge process is completed as described above. If the discharged reagent containers 21 and 22 are replaced by new ones and the door 45 is closed, requirements of steps S1 and S2 of the new replenishment process (refer to FIG. 8) are met. The new reagent containers 21 and 22 are detected in subsequent step S3, and the transfer process will be started. If no reagent container is added, the user removes the reagent container 21 and 22 from the setting portion 41, then closes the door 45. The process returns from step S3 of FIG. 8 to step S1 accordingly.

Note that the transfer process for new replenishment and discharge of the reagent containers described above can be performed in parallel with the measurement process of the sample analyzer 1. In the measurement process, the container storage 13 moves the reagent containers of the first holder 31 and second holder 32 to the reagent in conjunction with progress of dispensing operations by the reagent dispensing arms 6 through 8. The reagent container transfer operation is executed with an interval timing with the aspiration operation so as to not interfere with the aspiration operation and while preferentially executing the measurement process. Therefore, the replenishment and discharge of the reagent containers 21 and 22 is performed without interrupting the continuous measurements of samples.

In the first embodiment, the transfer of the reagent containers 21 and 22 starts automatically when the door 45 is closed. Therefore, by only closing the door 45 after the reagent containers 21 and 22 are set on the setting portion 41 through the opened door 45, the transfer of the reagent containers can be started immediately. The user does not have to input an instruction to transfer the containers via the input device. Hence, the burden of the user to move between the setting portion and the input device can be saved.

When the door 45 is closed and reagent containers 21 and 22 are not detected on the setting portion 41, the controller 2a of the first embodiment prohibits the operation of the transferring section 42. Hence, unnecessary transfer operation is prevented from starting even when the door 45 is closed by the user.

In the first embodiment, the door 45 is locked by the locking mechanism 46 when performing the transfer of the reagent containers 21 and 22. Therefore, the door 45 cannot be opened to insert an object into the setting portion 41 from the outside after the transfer operation started. Thus, the danger of a user mistakenly inserting a hand is avoided.

In the first embodiment, the transferring section 42 holds the reagent containers 21 and 22 on the setting portion 41 which is disposed above the container storage 13, and transfers the reagent containers 21 and 22 through the opening 13b on the top surface of the container storage 13 into the interior of the container storage 13. The structures related to the transfer of the reagent containers 21 and 22 can be made compact because the structures relating to the transfer of the reagent containers 21 and 22 to the container storage 13 are consolidated in the region above the container storage 13. Thus, enlargement of the apparatus is prevented.

In the first embodiment described above, the transfer of the reagent containers 21 and 22 from the setting portion 41 to the container storage 13 by the transferring section 42 is performed with only vertical movement (S direction movement). This simplifies the apparatus structure.

In the first embodiment described above, the setting portion 41 is configured to accommodate the reagent containers 21 and 22 side by side, and the transferring section 42 is capable of simultaneously holding both reagent containers 21 and 22. Hence, the reagent containers 21 and 22 can be transferred at the same time, and two reagent containers can be conveniently replaced at the same time.

### Second Embodiment

The second embodiment is described below with reference to FIGS. 3, 8, and 10. The second embodiment is described by way of example in which a transfer start button for issuing an instruction to start the transfer operation via the transfer device is provided near the setting portion unlike the first embodiment which provides the operation detection unit 44.

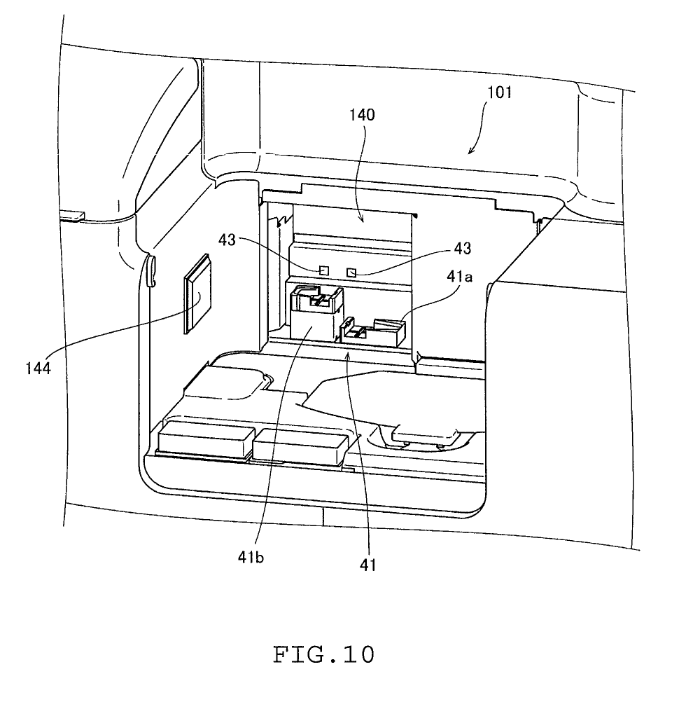

In the sample analyzer 101 of the second embodiment shown in FIG. 10, a transfer start button 144 is provided at a position on the inside of the casing cover 1 a, near the setting chamber 140. Note that in the second embodiment the transfer start button 144 replaces the operation detection unit 44, door 45, and locking mechanism 46 of the first embodiment.

The transfer start button 144 is configured as a push button switch. The user presses the transfer start button 144 after the completion of the setting operation of the reagent containers 21 and 22 on the setting portion 41. The ON signal of the transfer start button 144 is detected by the controller 102a.

In the second embodiment, the controller 102a (refer to FIG. 3) is configured to control the transferring section 42 to hold the reagent containers 21 and 22 on the setting portion 41 and transfer the reagent containers 21 and 22 to the container storage 13 based on the output of the container detector 43 and the output of the transfer start button 144. That is, the controller 102a starts the container transfer process when the user has turned on the transfer start button 144 and at least one reagent container is detected by the container detector 43. The controller 102a does not perform the container transfer process when the transfer start button 144 is not operated, or neither the reagent container 21 or reagent container 22 is detected by the container detector 43 after the transfer start button 144 has been pressed.

Other structures of the second embodiment are identical to those of the first embodiment.

In the reagent container transfer process of the second embodiment, whether the user has turned on the transfer start button 144 is detected instead of steps S1 and S2 of FIG. 8. The process continues to step S3 when the operation of the user turning on the transfer start button 144 is detected, and the determination of whether the user operating the transfer start button 144 is detected is repeated in a standby state by the controller 102a when the operation of the button is not detected. The content of other processes are identical to those of the first embodiment, and are therefore omitted from this description.

In the second embodiment, the transfer start button 144 is provided on the inside of the housing cover 1a near the setting chamber 140 to issue an instruction to start the transfer, and the transfer of the reagent containers 21 and 22 disposed on the setting portion 41 begins when the transfer start button 144 is operated and the container detector 43 detects the reagent containers 21 and 22 on the setting portion 41. Thus, the transfer of the reagent containers to the container storage 13 can be started by just operating the transfer start button 144 near the setting portion 41 to start the transfer after the reagent containers 21 and 22 have been set without the user moving to the input device installation to enter a reagent container transfer command. Hence the operation of setting the reagent containers can be conveniently completed near the setting portion 41. A mistaken operation of the user unintentionally operating the transfer start button 144 from outside is prevented by locating the transfer start button 144 inside the housing cover 1 a.

Other effects of the second embodiment are identical to those of the first embodiment.

The embodiments of the present disclosure are examples in all aspects and not to be considered limiting in any way. The scope of the present invention is expressed by the scope of the claims and not by the description of the embodiments, and includes all meanings and equivalences and modifications pertaining thereunto.

For example, although the sample analyzers in the embodiments are described by way of example applied to an immunological analyzer, type of analyzer is not limited to these examples. The present invention is applicable insofar as the sample analyzer equipped with a container storage and performs an analysis with a use of reagent stored in the reagent storage. Therefore the present invention is applicable to other types of sample analyzers other than immunological analyzer, for example, blood coagulation analyzer, biochemistry analyzer, blood cell counter, urine analyzer.

Although the first and second embodiments are described by way of example of two types of container including a large reagent container 21 and a small reagent container 22 set in the container storage 13, the present invention is not limited to this example. The shape of the container set in the container storage in the present invention also may be one type, or three or more types.

Although the first and second embodiments are described by way of example of a container storage accommodating a plurality of reagent containers 21 and 22 side by side in annular array, the present invention is not limited to this example. For example, the container storage also may be configured to store the reagent containers in linear array or matrix, or have a hierarchical structure with the reagent containers arrayed vertically.

Although the first and second embodiments are described by way of example providing three reagent dispensing arms 6 through 8 for aspirating reagent from the reagent containers 21 and 22 disposed in the container storage 13, the present invention is not limited to this example. The reagent dispensing arms may be provided one, two, or four or more.

Although the first and second embodiments are described by way of example providing container detectors configured by optical sensors, the present invention is not limited to this example. For example, the presence/absence of a container set on the setting base also may be detected by a contact sensor or a weight sensor. For example, providing retractable switches may be provided on the top surfaces of the setting bases 41a and 41b as an example of employing a weight sensor. The presence/absence of a container can be detected according to whether the retractable switch is depressed by the weight of the container.

Although the first embodiment is described by way of example providing a motion detector configured by an open/close sensor to detect a magnet built into the door, the present invention is not limited to this example. For example, an optical sensor may be provided as a motion detector. For example, when a transmission type sensor is used, the door disposed at the closed position will block the optical path, which can be detected; when a reflective type sensor is used, the reflected light from the door can be detected. Alternatively, a contact sensor which contacts the door at the closed position may be provided as the motion detector to detect the open and closed door.

Although the first embodiment is described by way of example of a gate employed as a door to open and close the entrance of the setting chamber, the present invention is not limited to this example. The gate may have another configuration insofar as the user access to the inside of the setting chamber is restricted. For example, rather than a single door as in the above embodiments, a dual door which opens from both sides also may be used as the gate. A sliding door also may be used instead of the hinged door of the above embodiments. The gate need not be a plate, since it may also be a lattice or bar.

Although the first embodiment is described by way of example of a locking mechanism locking the door before starting the transfer of the reagent containers, the present invention is not limited to this example. In the present invention, the door need not be locked before starting the transfer of the reagent containers. For example, the user may be alerted of the start of the container transfer by lighting an indicator light or the like to notify the user that the door is closed instead of physically locking the door.

Although the first and second embodiments are described by way of example of transferring the reagent containers from an opening on the top surface of the container storage, the present invention is not limited to this example. For example, an opening may be provided on a side surface of the container storage to transfer the reagent containers from the side of the container storage.

The first and second embodiments are described by way of example of apparatuses which use a common transfer device to perform both setting the reagent containers in the container storage and removing the reagent containers therefrom through a common opening, however the present invention is not limited to the example. In the present invention, a dedicated opening and transfer device may be provided for setting the reagent containers, and a dedicated opening and transfer device may be provided for removing the reagent containers.

Although the first and second embodiments are described by way of example of a transfer device configured to only move a holder in vertical directions, the present invention is not limited to this example. In the present invention, the transfer device may be configured to move the holder in horizontal directions rather than vertical directions.

The first embodiment is described by way of example of starting the transfer process when a reagent container is detected in step S3 after the door has been opened in step S1 and closed in step S2 in FIG. 8, however the present invention is not limited to the example. For example, a determination step S1a is added between the step S1 and S2 to determine whether the container detector is OFF. If the answer is YES, that is, the container detector is OFF, the process continues to step S2. If the answer is NO, that is, the container detector is still ON, the process loops step S1a. When the reagent container is ON in step S1a, it can be expected that the reagent containers discharged from the reagent storage remains. In this case, even if the door is closed erroneously, immediate initiation of the transferring reagent containers is not preferable. Therefore, by the modification, undesired transfer of discharged reagent container back to the container storage is prevented. It is more preferable that a message is issued when the discharged reagent container remains but the door is closed.

The first embodiment is described by way of example of starting the transfer process when a reagent container is detected in step S3 after the door has been closed in step S2 in FIG. 8, however the present invention is not limited to the example. In the present invention, a residual amount detecting unit also may be provided to detect the residual amount of reagent contained in the reagent container set on the setting portion, so that the transfer process is started only when the residual amount is greater than a predetermined amount. In this case, transferring a transferred empty reagent container back to the container storage is prevented.

For example, a transparent window may be provided on the side surface of the reagent container as an example of a residual amount detecting unit so that the liquid surface may be detected by irradiating a detection light from the side and receiving the transmitted light via an optical sensor. A weight sensor also may be provided on the setting base to determine whether the reagent weight is greater than a predetermined amount from the weight of the reagent container.

Although the first embodiment is described by way of example using a flow driven flow chart of the sequential processes along the process flow of the reagent container transfer process performed by the controller, the present invention is not limited to the example. In the present invention, the transfer process performed by the controller may also be performed by an event-driven process for executing processes as individual events. In this case, all processes may be event-driven or a combination of event-driven and flow-driven.

What is claimed is:

1. A sample analyzer comprising:
a container storage configured to store a plurality of reagent containers;
a setting chamber including within a setting portion on which at least one reagent container is set;
a container detector for detecting the reagent container on the setting portion;
a gate to open and close an entrance of the setting chamber;
a transferring section configured to hold the reagent container on the setting portion and transfer it to the container storage; and
a controller programmed to initiate the transferring section to transfer the reagent container from the setting portion to the container storage if the reagent container is set on the setting portion when the entrance of the setting chamber is closed by the gate.

2. The sample analyzer of claim 1, further comprising a gate sensor to detect when the entrance is closed by the gate.

3. The sample analyzer of claim 2, wherein the gate is a door,
the gate sensor is configured to detect closing of the door,
the controller is programmed to start the transfer by the transferring section when the door is closed after opening and a reagent container is detected.

4. The sample analyzer of claim 3, wherein the controller is programmed to prohibit the start of the transfer by the transferring section when the door has been closed but a reagent container is not detected.

5. The sample analyzer of claim 1, further comprising a locking mechanism for locking the gate;
wherein the controller is programmed to lock the gate via the locking mechanism before starting the transfer of the reagent container.

6. The sample analyzer of claim 1, wherein the container storage is provided with an opening, and
the transferring section is configured to hold the reagent container at the setting portion, and transfer the reagent container into the container storage through the opening of the container storage.

7. The sample analyzer of claim 6, wherein the setting portion is configured to be disposed above the container storage, and to be movable between a first position at which the opening is closed, and a second position at which the opening is open, and
the transferring section is configured to transfer the reagent container through the opening into the container storage by holding and lifting the reagent container on the setting portion at the first position, and lowering the setting portion while the setting portion is at the second position.

8. The sample analyzer of claim 7, wherein the container storage comprises a plurality of slots capable of respectively holding reagent containers,
the controller is programmed to operate the container storage so as to position an empty slot among the plurality of slots below the opening before starting a transfer.

9. The sample analyzer of claim 8, wherein the controller is programmed to output an alert when there is no empty slot.

10. The sample analyzer of claim 1, wherein the controller is programmed to cause the transferring section to remove the reagent container from the container storage and set the reagent container on the setting portion when an instruction is received to remove the reagent container from the container storage.

11. The sample analyzer of claim 1, wherein the setting portion is configured to receive a plurality of reagent container,
the transferring section is configured to simultaneously hold the plurality of reagent containers, and
the controller is programmed to cause the transferring section to transfer the reagent container to the container storage when the entrance is closed and at least one reagent container is detected.

12. The sample analyzer of claim 1, further comprising a measurement section for detecting the components contained in a sample processed using the reagent stored in the container storage.

13. A sample analyzer comprising:
a container storage configured to store a plurality of reagent containers;
a setting portion configured to accommodate at least one reagent container;
a container detector for detecting a reagent container placed on the setting portion;
a transferring section configured to hold the reagent container on the setting portion and transfer it to the container storage;
a cover forming an exterior of the sample analyzer; and
a button for issuing an instruction to start the transfer by the transferring section provided within the cover near the setting portion,
wherein the setting portion is configured so as to be exposed when the cover is open, and
the transferring section is configured to start transferring a reagent container placed on the setting portion when the button is operated and a reagent container is detected on the setting portion.

14. A method for loading reagent container in a container storage of a sample analyzer, comprising the steps of:
setting at least one reagent container on a setting portion within a setting chamber through an entrance of the setting chamber;
closing the entrance with a gate equipped with the sample analyzer; and
starting loading of the reagent container on the setting portion into the container storage by a transferring section of the analyzer when triggered by the closing of the gate on the entrance.

15. The method of claim 14, wherein
the transferring section holds the reagent container placed on the setting portion and transfers the reagent container to the container storage.

16. The method of claim 14, wherein
the gate is locked by a locking mechanism of the sample analyzer before starting the transfer of the reagent container.

17. The method of claim 14, wherein
the setting portion covers an opening of the container storage and is provided so as to slide horizontally, and
the transfer of the reagent container by the transferring section further comprises:
holding the reagent container on the setting portion by the transferring section;
lifting the transferring section;
sliding the setting portion horizontally to open the opening; and
lowering the transferring section and the reagent container held by the transferring section through the opening.

18. The method of claim 14, wherein
the transferring section simultaneously transfers a plurality of reagent containers from the setting portion to the container storage when a plurality of reagent containers are detected.

19. The method of claim 14, further comprising a step of
positioning an empty slot at a position to receive the transferred reagent container.

20. The method of claim 19, wherein
an alert is output when there is no empty slot.
